(19) United States
(12) Patent Application Publication
(10) Pub. No.: US 2008/0211217 A1
(43) Pub. Date: Sep. 4, 2008

(54) Adjustable Steering System

(75) Inventor: Anthony J. Sanville, Evans, GA (US)

Correspondence Address: HARNESS, DICKEY & PIERCE, P.L.C., P.O. BOX 828, BLOOMFIELD HILLS, MI, 48303, US

(73) Assignee: TEXTRON INC., Providence, RI (US)

(21) Appl. No.: 11/681,339

(22) Filed: Mar. 2, 2007

(51) Int. Cl. B62D 1/18

(52) U.S. Cl. 280/775

(57) ABSTRACT

An adjustable steering system for a golf car includes a steering column assembly and a shaft having a cylindrically shaped body and a non-circular engagement end axially extending from the body. A first U-joint includes a first yoke connected to the shaft and a second yoke connected to the steering column assembly. A second U-joint includes a first yoke member having a pair of deflectable members and an oppositely positioned pair of forks. The deflectable members receive and frictionally engage the engagement end of the shaft. A second yoke member includes a pair of forks to engage the pair of forks of the first yoke member. The engagement end of the shaft is releasably engaged by the deflectable members permitting an engagement length of the engagement end positioned between the deflectable members to be axially varied.

### FIELD

The present invention relates to an adaptable steering column for a small utility vehicle which allows the rake or angle of the steering wheel to be modified while maintaining engagement with a pinion gear.

### BACKGROUND

The statements in this section merely provide background information related to the present disclosure and may not constitute prior art. Small utility vehicles such as: golf cars, shuttle personnel carriers, refreshment vehicles, industrial utility vehicles, and/or trail utility vehicles have many uses. Such vehicles accommodate a wide range of different-sized drivers.

In steering systems designed for a small utility vehicle such as a golf car, movement of a steering shaft rotated by operating a steering wheel is transmitted to an input shaft of a steering gear via a pair of universal joints. An angle provided by a two or more component column steering assembly can be derived from the relative pivoting of the steering column shaft at the universal joints which connect the steering bar to the column steering shaft.

In prior adjustable steering systems, the two sections of the steering column are connected with one another by a spring and damper cylinder which can be used to lock the sections in many desired positions thus supporting the weight of the steering wheel as its position is changed. Each steering position requires adjustment of the length of the lower column shaft coupling the two universal joints by incorporating different lower column shaft parts of different lengths. For example, a steering column assembly is designed so the steering wheel may be useable by a multitude of small utility vehicles. If mounted at a high-angle position, a shorter operator can have difficulty reaching the steering wheel. If mounted at a low-angle position, a tall operator's legs can interfere with the bottom portion of the steering wheel. Therefore, a “compromise” steering column assembly orients the steering wheel between a low-angle position preferred by the shorter operator, and a high-angle position preferred by the taller operator. This allows each operator to drive the utility vehicle, but not in the most accommodating circumstances.

Having a fixed lower column shaft can increase costs in a small utility vehicle when various steering column angles are designed with a multitude of steering column parts. Additional parts can also increase the complexity of the small utility vehicle that can introduce additional maintenance. Manufacturers often produce more than one type of small utility vehicle. To reduce costs, the manufacturer can use a common steering column assembly design for various types of small utility vehicles. A common lower column shaft design, however can be difficult to incorporate when different types of small utility vehicles require different steering column positions necessitating different column shaft lengths.

### SUMMARY

In various embodiments there is provided a steering column having an adjustable or variable length. The adjustable steering column includes a steering bar and a column steering shaft that can be axially moveable relative to one another. The steering bar can be connected with the steering wheel. The steering column shaft can be drivingly connected to the steering bar on one end and can include a first universal joint connection with the steering bar permitting relative axial movement of the lower column shaft while maintaining a rotary drive connection between the steering bar and the lower column shaft. A second universal joint on the lower column shaft distal to the steering wheel is slidably attached to the lower column shaft and connectable with a pinion gear-rack steering mechanism of the vehicle. The length of the lower column shaft can be made adjustable by a second universal joint having an adjustable collar slidably connected to the lower column shaft.

The lower column shaft includes a first and a second universal joint. The second universal joint is distal to the steering wheel, and can be slideably connected to a splined portion of a lower column shaft. The lower column shaft can be connected to the pinion gear with a yoke of the slideably adjustable second universal joint allowing multiple steering column positions adaptable for a plurality of utility vehicles. The second universal joint of the lower column shaft can slide along the splined portion of the lower column shaft while still maintaining engagement with the pinion gear for functionality.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a side perspective view of a golf car including an adjustable steering system assembly according to the present disclosure;

FIG. 2 is a side perspective view of a golf car frame, steering and suspension system according to various embodiments;

FIG. 3 is a front elevational view of an adjustable steering column and rack and pinion assembly;

FIG. 4 is a side elevational view of the lower column shaft of FIG. 3;

FIG. 5 is a longitudinal cross-section of the lower column shaft;

FIG. 6 is a side elevational view of two steering column positions embodying the invention;

FIG. 7 is a side elevational view of the steering column position variable from a first position to a second position when coupled to the universal joints; and

FIG. 8 is a perspective view of the steering column bracket connected to the frame of FIG. 2 shown rotatable from a first orientation to a second orientation.

### DETAILED DESCRIPTION

The following description is merely exemplary in nature and is not intended to limit the present disclosure, application, or uses. It should be understood that throughout the drawings, corresponding reference numerals indicate like or corresponding parts and features.

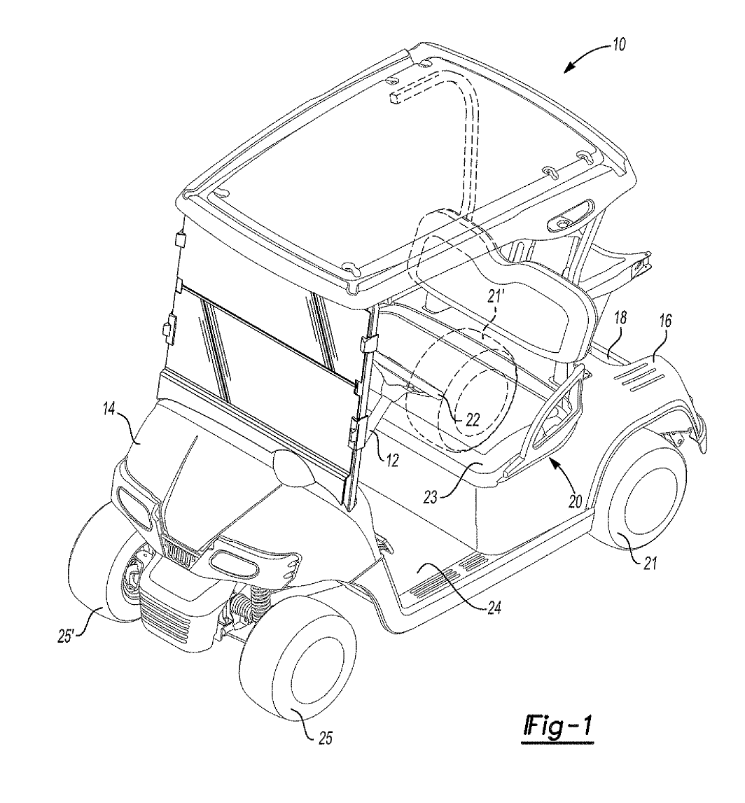

Referring generally to FIG. 1, according to several embodiments, a small utility vehicle which as an example is referred to hereinafter as a golf car 10 includes an adjustable steering system 12. The adjustable steering system 12 is not limited for use with golf cars and can also be used with other small utility vehicles for example, but not limited to: shuttle personnel carriers, refreshment vehicles, industrial utility vehicles, and/or trail utility vehicles. Golf car 10 further includes a front end 14, a rear end 16 having a golf bag storage area 18, a passenger seating area 20, and rear driven wheels 21, 21′. The seating area 20 includes adjustable steering system 12, a steering wheel 22, a seat 23, and a floor portion 24. Golf car 10 further includes first and second steerable vehicle wheels 25, 25′. Additional embodiments can include one or more than two steerable vehicle wheels.

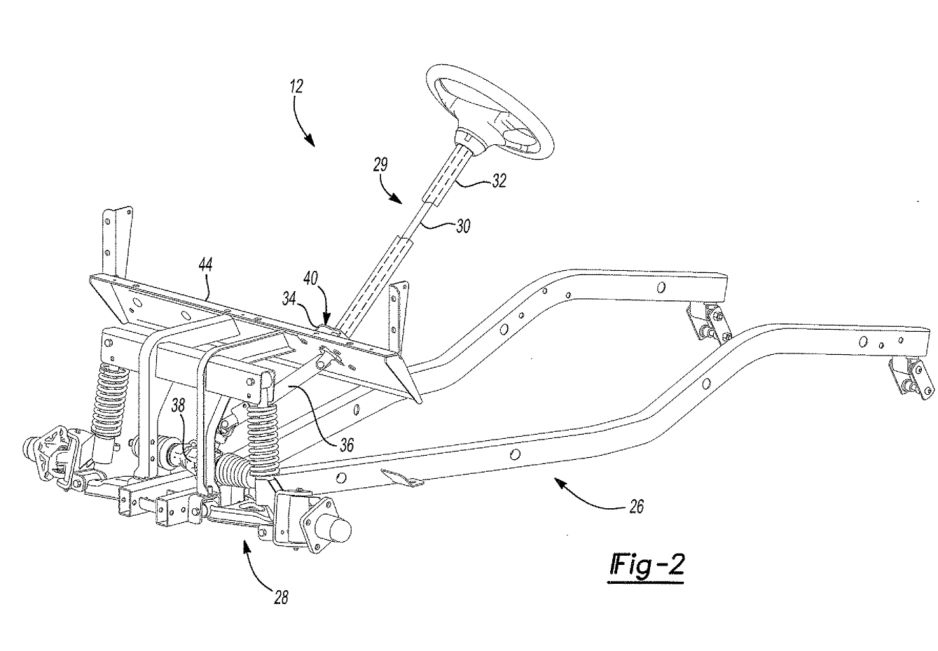

As best seen in FIG. 2 adjustable steering system 12 can be connected to a frame assembly 26 which includes a front suspension system 28 connected thereto. Adjustable steering system 12 includes a steering column assembly having a steering bar 30 which is rotatably received in a tubular steering column 32. Adjustable steering system 12 also includes a bracket 34, a lower column shaft 36, and a rack and pinion steering assembly 38. The bracket 34 can be formed from a metal material. The steering column 32 can be rigidly attached to a face 40 of the bracket 34 by a weld such as a fillet weld. The steering column 32 can be attached orthogonally or non-orthogonally with respect to face 40. A non-orthogonal orientation allows for an angular orientation of the bracket 34 when connected to a structural panel 44 to create different positions for steering column 32.

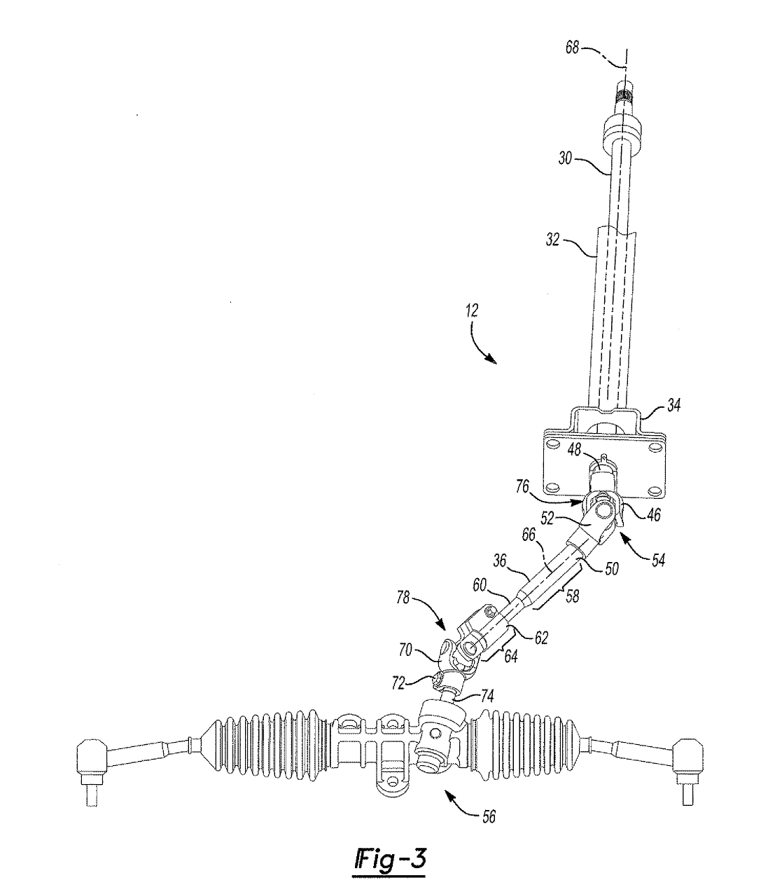

With reference now to FIG. 3, steering bar 30 is rotatably received within steering column 32 and partially freely extends through bracket 34 to connect with a universal joint yoke 46. An end 48 of steering bar 30 oppositely located from steering wheel 22 (not shown in this view), attaches to yoke 46. An end 50 of adjustable lower column shaft 36 connects to a universal joint yoke 52 which together with yoke 46 define a universal yoke assembly or U-joint 54. U-joint 54 assists in transferring rotational motion from steering bar 30 and lower column shaft 36 to a steering system 56. The steering system 56 can be, by way of non-limiting examples, a rack and pinion system, a recirculation ball system, or a steering linkage system. Steering system 56 converts the rotational motion from steering wheel 22 through the steering bar 30 to steer golf car 10 accordingly.

With further reference to FIG. 3, when steering bar 30 is axially rotated, a rotational force is transmitted through U-joint 54 to lower column shaft 36. Lower column shaft 36 includes a cylindrical tube 58 which tapers into a non-circular engagement end 60. Engagement end 60 is slidably received within and adjustably connected to a yoke member 62. Yoke member 62 defines a portion of a universal yoke assembly or second U-joint 64. In various embodiments, lower column shaft 36 defines a shaft longitudinal axis 66 which is pivotable using U-joint 54 with respect to a longitudinal axis 68 of steering bar 30. It is contemplated that an angular relationship between axis 66 of the lower column shaft 36 and longitudinal axis 68 of steering bar 30 can vary within an angular range of approximately 0° to 90° depending on the placement of steering wheel 22 and bracket 34 in golf car 10. When lower column shaft 36 axially rotates, the steering system 56 is actuated to turn the steerable vehicle wheels 25, 25′. Engagement end 60 of lower column shaft 36 is releasably, axially positionable within yoke member 62 to accommodate multiple angles within an angular range of approximately 0° to 90° to direct the rotational input from steering wheel 22 to steer golf car 10 accordingly.

U-joint 64 further includes a yoke member 70 similar to yoke 46. Yoke member 70 is provided with a fastener 72 which allows yoke member 70 to releasably engage a shaft 74 which is received by steering system 56. Shaft 74 can in turn couple to a pinion gear (not shown) of steering system 56. U-joint 54 defines a first rotatable joint assembly 76 and U-joint 64 defines a second rotatable joint assembly 78.

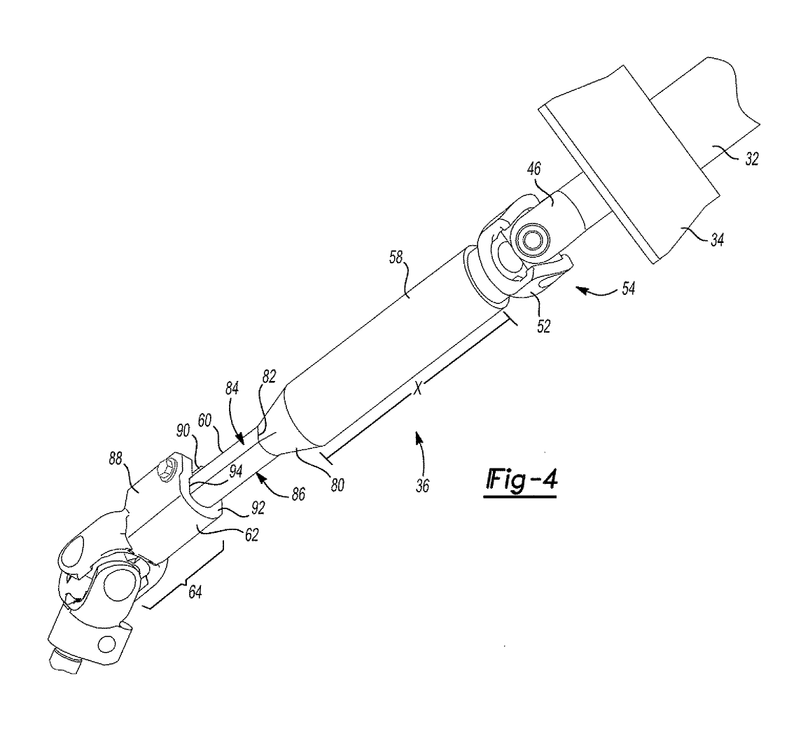

As best seen in reference to FIG. 4, lower column shaft 36 can be manufactured with yoke 52. In some embodiments, cylindrical tube 58 of lower column shaft 36 has a length “X” which extends at a tapered portion 80 to a substantially non-circular transition 82 from which engagement end 60 axially extends. In several embodiments, engagement end 60 includes opposed flat faces 84, 86. Yoke member 62 can include opposed deflectable wings 88, 90 which both define a U-shaped receiving end 92. The receiving end 92 includes a non-circular shaped aperture 94 which is shaped to matingly receive engagement end 60. Engagement end 60 of lower column shaft 36 can be inserted into the aperture 94 of receiving end 92. In several embodiments, non-circular engagement end 60 can also be referred to as the splined portion of lower column shaft 36, which non-rotatably engages with the receiving end 92. In some embodiments, engagement end 60 of lower column shaft 36 is square or rectangular in shape. It is anticipated that one of ordinary skill in the art can manufacture engagement end 60 having any geometric shape including, without limitation, triangular, rhomboid, trapezoidal, hexagonal and combinations thereof that resist rotational slippage when inserted into a similarly shaped aperture 94.

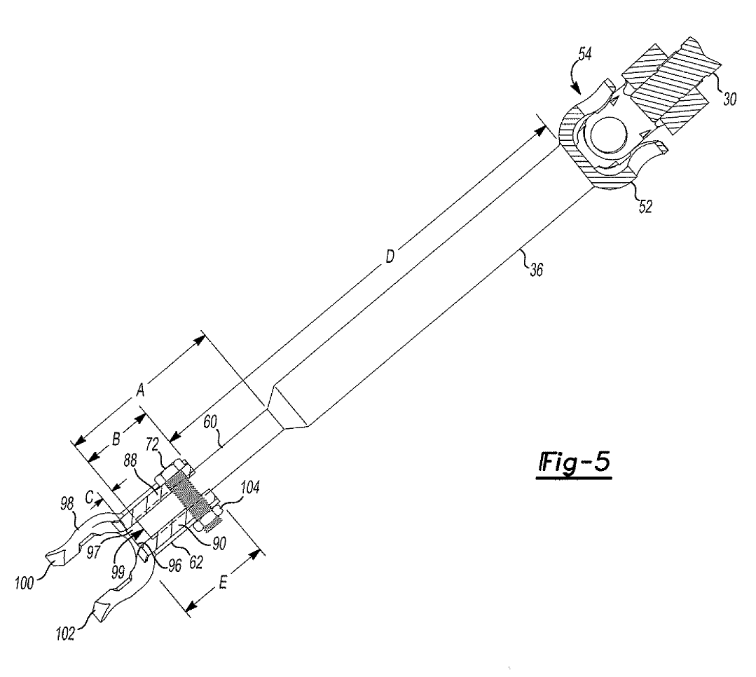

Referring now to FIG. 5, engaging end 60 of lower column shaft 36 has a total length “A” which can be received for an engagement length “B” within yoke member 62, allowing extension/retraction of lower column shaft 36 between universal joint assemblies 54 and 64. A terminal end 96 of an engagement end receiving cavity 97 of yoke member 62 located proximate to a U-joint coupling member 98 defines a maximum depth of insertion of engagement end 60. A clearance dimension “C” is created between an end face 99 of engagement end 60 and terminal end 96 when engaging end 60 is partially retracted from receiving end 92 of yoke member 62. Clearance dimension “C” can therefore vary from 0 when engagement end 60 is fully inserted (end face 99 is in contact with terminal end 96) up to approximately 25 mm when engagement end 60 is partially withdrawn. U-joint coupling member 98 includes first and second forks 100, 102 which couple with similar forks of yoke member 70. As shown in longitudinal cross section opposed deflectable wings 88, 90 of yoke member 62 can be biased toward each other by tightening fastener 72 using a nut 104 to frictionally grasp engagement end 60. A free length “D” of lower column shaft 36 is created when fastener 72 and nut 104 are torqued. A cavity depth or length “E” defines the total depth of cavity 97 and therefore the maximum engagement length “B” of engagement end 60.

In some embodiments, lower shaft column 36 is created of a metal material or similar structural material, including, without limitation, steel, steel alloy, titanium, aluminum and combinations thereof. The lower column shaft 36 including cylindrical tube 58, engagement end 60, the universal joint assemblies 54 and 64, and yoke member 62 can be formed by extruding, stamping, rolling, hydroforming, forging, or similar manufacturing processes. In some embodiments, cylindrical tube 58 can be either solid or hollow. In still other embodiments, engagement end 60 can be solid or hollow. In additional embodiments, yoke member 62 and U-joint coupling member 98 can be formed of a single piece of metal or multiple pieces welded together.

In various embodiments, nut 104 can be tightened on fastener 72 using at least 15 Newton-meters of torque. As nut 104 is tightened, deflectable wings 88, 90 constrict around engagement end 60 which can bear the same shape as the aperture 94 formed within the receiving end 92. Fasteners 72 and 104 can be bolts and nuts, but one skilled in the art will recognize that other fastening arrangements can be utilized. In several embodiments, engagement end 60 can be longer than yoke member 62. In several embodiments, receiving end 92 can also be partially beveled to more easily receive engagement end 60.

Referring again to FIG. 4, engagement end 60 can be inserted into the receiving end 92 at different lengths to create multiple positions of yoke 46 of U-joint 54 which can be fixed to steering bar 30. When a change in angle of steering column 32 is required, lower column shaft 36 can be axially repositioned by changing a depth of engagement of engagement end 60 in yoke member 62 to accommodate a required distance between yoke 46 of the first U-joint and yoke member 62 of second U-joint 64 fixedly attached to steering system 56. Thus, axial engagement length adjustments of engagement end 60 between 0 and 25 millimeters can be made to maintain engagement between both sets of U-joints, translating steering column angle rotational force from steering wheel 22 through steering bar 30 to steering universal joint yoke 52 for any steering column position. The steering system 56 converts the rotational motion from steering bar 30 to steer golf car 10 accordingly, without rotational slippage between yoke member 62 and engagement end 60.

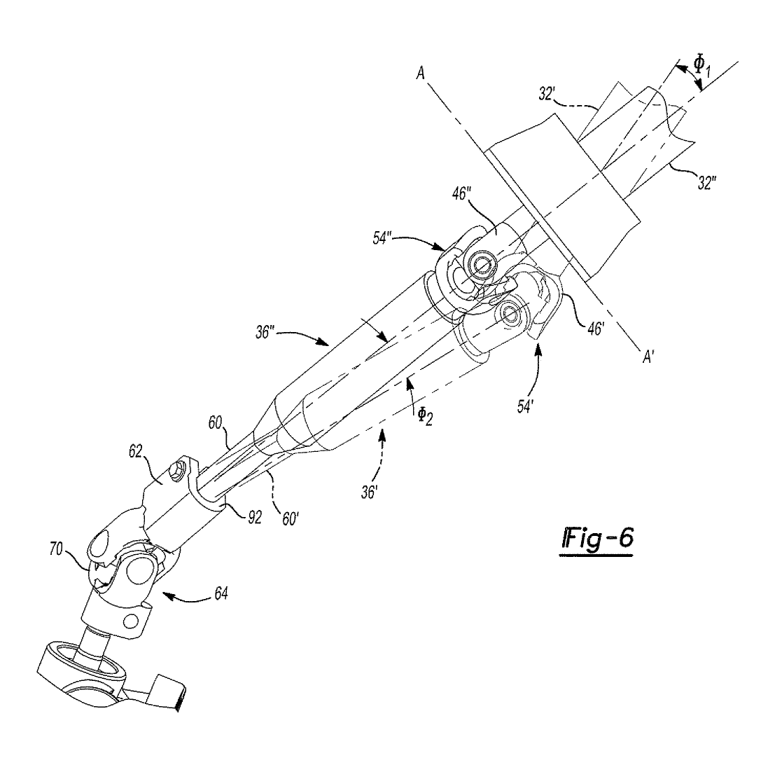

Referring generally now to FIG. 6, details of the orientation of the multi-angled and adjustable steering column is shown. More specifically, superposition of a column position 1 (shown in phantom) over a column position 2 is shown. Steering column 32 at position 2 is deflected by an angle Φ in relation to the original orientation of the steering column 32 in position 1. As the steering column angle is increased from steering column position 1 to steering column position 2 relative to axis A-A′, a corresponding change in orientation occurs in first U-joint 54 and yoke 46 with respect to a plane A-A′. To accommodate the change in position of yoke 46, lower column shaft 36 can be angularly repositioned with respect to the plane A-A′ by changing the depth of engagement “B” of engagement end 60, with yoke member 70 of second U-joint 64 remaining substantially stationary. To compensate for the change in angle of lower column shaft with respect to axis A-A′ from position 1 to position 2, a distance between yoke 46 of first U-joint 54, and yoke member 70 of second U-joint 64 is increased, thus engagement end 60 of lower column shaft 36 is partially retracted from yoke member 62 at receiving end 92 between 0 and 25 millimeters to increase the free length of lower column shaft 36. Free length extension of lower column shaft 36 is required to keep both universal joints 54 and 64 engaged with lower column shaft 36. Conversely, when angle Φ of steering column 32 is decreased, the distance between U-joints 54 and 64 decreases, thus requiring an axial reduction of the free length of lower column shaft 36. To accommodate this reduction, the engagement end 60 is more fully inserted into receiving end 92 of yoke member 62 within the range of 0 to about 25 mm.

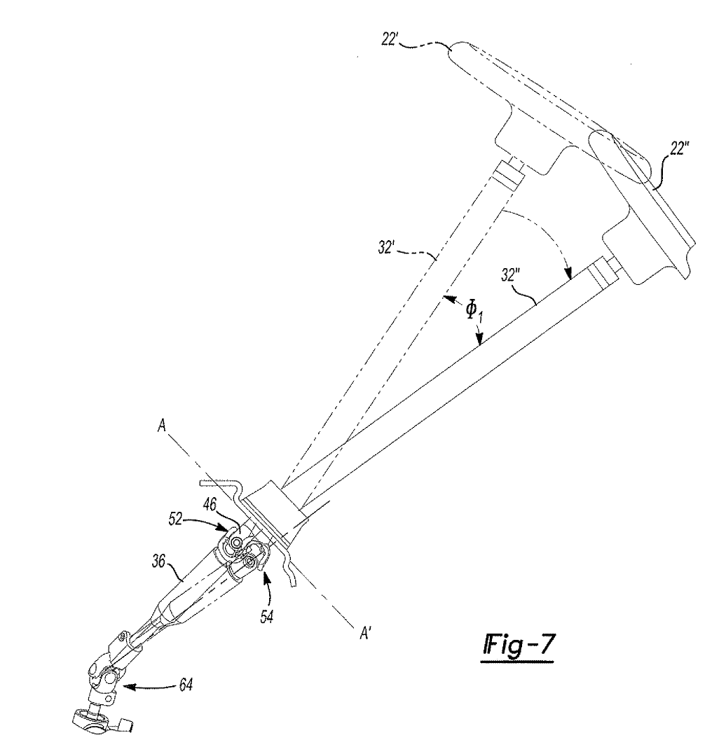

Referring generally to FIGS. 6 and 7, the relative angular change of the first U-joint 54 with respect to yoke member 70 is proportional to the change in steering column angle. When steering column 32 is angularly repositioned from position 1 shown as steering column 32′ by Φ₁ degrees, position 2 of steering column 32′ is created and U-joint 54 is angularly moved by Φ₂ degrees. The change in orientation of first U-joint 54 shifts the axis of lower column shaft 36 by Φ₂ degrees. The first and second U-joints 54 and 64 can remain coupled when the free length “D” of the lower column shaft 36 is increased or decreased corresponding to a steering column position change. To change the free length “D” of lower column shaft 36, fastener 72 and nut 104 are loosened. The engagement end 60 of lower column shaft 36 received within yoke member 62 is slidably adjusted within the previously identified range from about 0 to about 25 millimeters. Once the lower column shaft 36 free length “D” has been adjusted, the engagement length “B” of engaging end 60 of lower column shaft 36 in yoke member 62 is frictionally engaged by re-torqueing fastener 72 and nut 104.

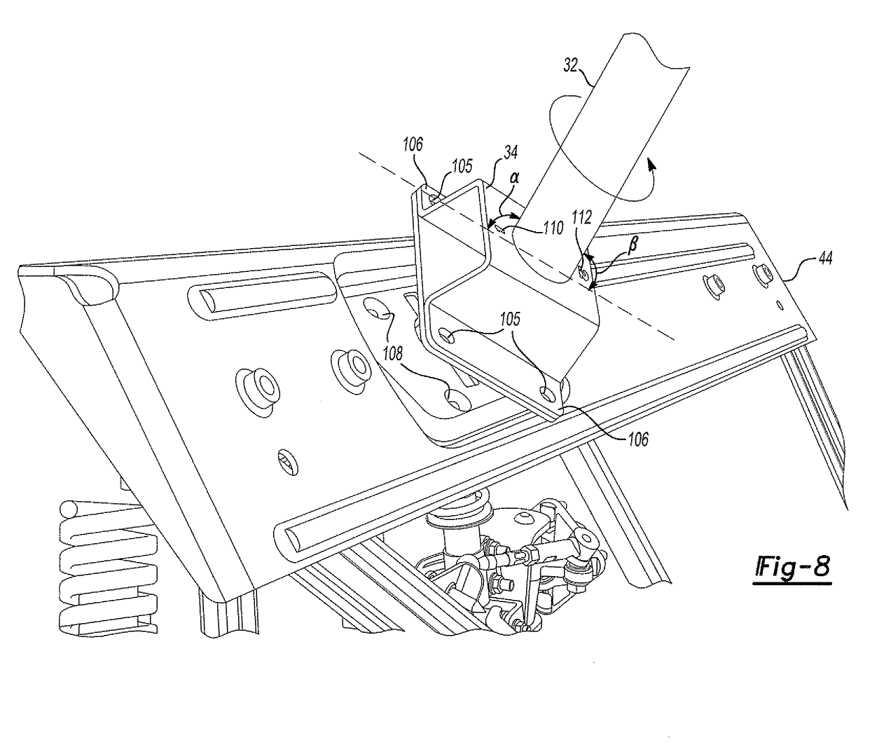

As best seen in reference to FIG. 8, steering column 32 can be fixedly coupled to golf car 10 using one or more brackets 34. According to various embodiments, steering column 32 can also have two or more fixed positions based on a pre-selected orientation of bracket 34. To accomplish this, bracket 34 includes a plurality of apertures 105 located on generally flat, flanged portions 106. The apertures 105 align with base apertures 108 created in structural panel 44. Fasteners (not shown) can be inserted through bracket apertures 105 and base apertures 108 to fixedly attach bracket 34 to structural panel 44. Typically, the fasteners can be screw-type fasteners, but one skilled in the art will recognize other fastening arrangements can be utilized. The fasteners are removable to change the orientation or position of bracket 34.

First and second position markings 110, 112 are created at selected locations on face 40 of bracket 34. According to various embodiments, a position marking at the top of bracket 34 identifies a corresponding position of steering column 32. When the first position marking 110 is on top, bracket 34 is in the first orientation. A first angle α is defined between steering column 32 and bracket 34. More specifically, first angle α is defined between the portion of bracket 34 that includes the first position marking 110 and steering column 32. When bracket 34 is parallel with structural panel 44, first angle α can also be defined between the steering column 32 and structural panel 44.

According to various embodiments, steering column 32 can be non-orthogonal with respect to structural panel 44 only in a longitudinal plane of golf car 10. This creates two distinct steering wheel heights for golf car 10 when bracket 34 is rotated 180 degrees about a fixed axis. Therefore, as shown in FIGS. 7 and 8, the assembler has a preference between the two heights of steering wheel 22. The axially adjustable lower column shaft 36 can also be used as a common part in different types of small utility vehicles that require different steering wheel heights and angles.

In some implementations, bracket 34 can have more than two orientations. The number of orientations for bracket 34 determines the number of steering column positions. For example, if bracket 34 can only be installed by rotating 180 degrees, the steering column 32 will have two unique positions. If bracket 34 can be oriented by rotating at 90 degree increments, steering column 32 will have four unique positions. In FIG. 8 bracket 34 is shown during rotation about a fixed axis between orientations. The second position marking 112 identifies the second orientation of bracket 34 which corresponds to a distinct steering column position. A second angle β is defined between the steering column 32 and bracket 34. More specifically, second angle β is defined between the portion of bracket 34 that includes the second position marking 112 and steering column 32. When bracket 34 is parallel with structural panel 44, the second angle β can also be defined between the steering column 32 and the structural panel 44.

Referring now to both FIGS. 7 and 8, steering column 32 can be positioned in the first position when the first position marking 110 is toward the top of bracket 34. The steering column 32 can be changed to the second position, shown in FIG. 7 as position 2 when bracket 34 is turned 180 degrees so that the second position marking 112 is oriented toward the top of bracket 34.

A multi-angle adjustable length steering column assembly of the present disclosure provides several advantages and includes a steering bar within a steering column. The steering column includes a bracket that is rigidly attached to a steering column. The bracket attaches to a base in more than one orientation allowing for more than one steering column position. The lower column shaft can further include a first and second universal joint assembly operatively linked to the steering bar and the pinion gear mechanism respectively. The lower column shaft includes at least one yoke which is part of a universal joint assembly. The second universal joint of the lower column shaft can be angularly adjusted to enable the steering column to be positioned in an angular range of approximately 0 to 90 degrees, and thereby produce a plurality of steering column angles. The second universal joint yoke of the lower column shaft can further include a collar which receives an engagement portion of the lower column shaft allowing axial adjustment of the lower column shaft to enable the steering column to be axially lengthened from approximately 1 to 25 mm inclusive. This enables selection of one or more steering column positions by selectively altering the angle of the steering column thus altering the length of the adjustable lower column shaft to engage the steering column and steering pinion gear, and allows use of a common part for different types of small utility vehicles.

The description herein is merely exemplary in nature and, thus, variations that do not depart from the gist of that which is described are intended to be within the scope of the disclosure. For example, adjustable lower column shafts used in various steering system U-joints of the present disclosure are described herein with respect to use in a golf car steering system, however, the present disclosure is not limited to adjustable steering systems for golf cars and can be implemented for use in may other vehicles such as off-road vehicles, all terrain vehicles and the like. These other vehicles can include maintenance vehicles, hunting/sport activity vehicles, passenger shuttle vehicles, food/beverage carts, golf course maintenance vehicles, and the like. Such variations are not to be regarded as a departure from the spirit and scope of the disclosure.

What is claimed is:

1. An adjustable steering system shaft assembly for a utility vehicle, comprising:
a shaft having a substantially non-circular engagement end and a second end;
a first universal joint having a first yoke connected to the second end and a second yoke adapted for connection to a steering column; and
a second universal joint having a first yoke member including a substantially U-shaped receiving end defining a non-circular aperture adapted to frictionally and releasably engage the non-circular engagement end of the shaft;
wherein a free length of the shaft positioned between the first and second universal joints is determined in part by a partial length of the engagement end disposed within the first yoke member.

2. The shaft assembly according to claim 1, wherein the first yoke member further comprises:
a first deflectable wing; and
a second deflectable wing;
wherein the non-circular aperture is created between the first and second deflectable wings.

3. The shaft assembly according to claim 2, further comprising:
a fastener insertable through both the first and second deflectable wings; and
a nut engageable with the fastener, the nut and fastener operable to deflect the first and second deflectable wings toward each other to frictionally engage the engagement end therebetween.

4. The shaft assembly according to claim 1, wherein the non-circular engagement end comprises opposed flat faces.

5. The shaft assembly according to claim 1, wherein the non-circular engagement end comprises one of a rectangular shape, a triangular shape, a rhomboid shape, a trapezoidal shape, and a hexagonal shape.

6. The shaft assembly according to claim 2, wherein the receiving end comprises a partial bevel to receive the engagement end.

7. The shaft assembly according to claim 1, wherein the length of the non-circular engagement end is greater than a length of the first yoke member.

8. The shaft assembly according to claim 1, wherein the length of the engagement end disposed within the first yoke member is variable by a clearance dimension ranging from about 0 to about 25 millimeters.

9. The shaft assembly according to claim 1, further comprising a second yoke member of the second universal joint adapted for connection to a steering assembly.

10. An adjustable steering system for a golf car, comprising:
a steering column assembly;
a shaft having a generally cylindrically shaped body and a substantially non-circular engagement end axially extending from the body;
a first U-joint including a first yoke connected to the shaft and a second yoke connected to the steering column assembly; and
a second U-joint including:
a first yoke member having a pair of deflectable members and an oppositely positioned pair of forks, the deflectable members adapted to receive and frictionally engage the engagement end of the shaft; and
a second yoke member including a pair of substantially parallel forks adapted to engage the pair of forks of the first yoke member;
wherein the engagement end of the shaft is releasably engaged by the deflectable members permitting an engagement length of the engagement end positioned between the deflectable members to be axially varied.

11. The shaft assembly according to claim 10, further comprising:
an engagement end receiving cavity defined by the deflectable members having a terminal end; and
an end face of the engagement end;
wherein the end face is movable with respect to the terminal end by a predetermined distance.

12. The shaft assembly according to claim 11, wherein the predetermined distance ranges between 0 to approximately 25 mm.

13. The shaft assembly according to claim 10, wherein the steering column assembly further comprises:
a steering column outer shaft; and
a steering bar rotationally received in the outer shaft.

14. The shaft assembly according to claim 10, further comprising a bracket adapted to fixedly receive the steering column outer shaft, the bracket having at least first and second position markings operable to orient an angular orientation of the steering column.

15. The shaft assembly according to claim 10, wherein the shaft is substantially hollow.

16. The shaft assembly according to claim 10, further comprising a fastener adapted to deflect the deflectable arms to releasably engage the engagement end.

17. A golf car, comprising:
at least one steerable wheel controlled by rotation of a steering wheel;
a steering column assembly connected to the steering wheel; and
an adjustable steering system connecting the steering column assembly to the at least one steerable wheel, including:
a shaft having a substantially non-circular engagement end and a second end;
a first universal joint having a first yoke connected to the second end and a second yoke adapted for connection to the steering column assembly; and
a second universal joint having a first yoke member including a substantially U-shaped receiving end defining a non-circular aperture adapted to frictionally and releasably engage the non-circular engagement end of the shaft;
wherein an angular orientation of the steering column with respect to the shaft is predetermined by an engaged length of the engagement end disposed within the first yoke member.

18. The golf car according to claim 17, further comprising:
a structural panel connected to a frame of the golf car; and
a bracket, the steering column being fixedly connected to the bracket, the bracket being selectively connectable to the structural panel to provide at least two angular positions of the steering column.

19. The golf car according to claim 18, wherein the steering column assembly further comprises:
a steering column outer shaft; and
a steering bar rotationally received in the outer shaft.

20. The golf car according to claim 19, wherein the steering bar is freely disposed through the bracket to connect to the second yoke of the first universal joint.

21. The golf car according to claim 17, wherein the non-circular aperture is adapted to mimic a geometric shape of the engagement end.

22. The golf car according to claim 17, wherein the engaged length of the engagement end is operably variable within a range of 0 to approximately 25 millimeters.

23. A method for creating an adjustable steering system for a utility vehicle, the adjustable steering system having a column shaft including a generally cylindrical body with a non-circular engagement end, first and second U-joints, a steering column assembly having an outer sleeve and an inner rotatably disposed steering bar, and a bracket, the method comprising:
fixing the outer sleeve to the bracket having the steering bar rotatably extending through the bracket;
connecting both the steering bar and the column shaft to the first U-joint;
releasably engaging the engagement end to the second U-joint; and
adjusting an engaged length of the engagement end in the second U-joint to operably vary an angle of the steering column.

24. The method according to claim 23, further comprising controlling the adjusting step by sliding the engagement end in the second U-joint within a range of 0 to 25 mm.

25. The method according to claim 23, further comprising fastening the second U-joint to the engagement end to prevent rotational movement of the column shaft with respect to the second U-joint.

26. The method according to claim 23, further comprising connecting the second U-joint to a rack and pinion steering system.
